(19) United States
(12) Patent Application Publication
(10) Pub. No.: US 2021/0409872 A1
(43) Pub. Date: Dec. 30, 2021

(54) Electroacoustic Transducer

(71) Applicant: Yamaha Corporation, Hamamatsu-shi (JP)

(72) Inventor: Masao NORO, Hamamatsu-shi (JP)

(21) Appl. No.: 17/474,385

(22) Filed: Sep. 14, 2021

Related U.S. Application Data
(63) Continuation of application No. PCT/JP2020/005992, filed on Feb. 17, 2020.

(30) Foreign Application Priority Data
Mar. 15, 2019 (JP) 2019-048766

(51) Int. Cl. H04R 19/01; B06B 1/02

(52) U.S. Cl. CPC H04R 19/016; B06B 1/0292

(57) ABSTRACT

An electroacoustic transducer includes a first fixed electrode, a second fixed electrode, and a vibration body. The first and second fixed electrodes face each other across a space. The first fixed electrode includes first protrusions that are provided on a first electrode surface of the first fixed electrode and that protrude toward the second fixed electrode. The first protrusions are arranged at a first arrangement density that varies depending on a position of the first protrusions on the first electrode surface. The second fixed electrode includes second protrusions that are provided on a second electrode surface of the second fixed electrode and that protrude toward the first fixed electrode. The second protrusions are arranged at a second arrangement density that varies depending on a position of the second protrusions on the second electrode surface. The vibration body is sandwiched between the first protrusions and the second protrusions.

### CROSS-REFERENCE TO RELATED APPLICATIONS

The present application is a continuation application of International Application No. PCT/JP2020/005992, filed Feb. 17, 2020, which claims priority to Japanese Patent Application No. 2019-048766, filed Mar. 15, 2019. The contents of these applications are incorporated herein by reference in their entirety.

### BACKGROUND

### Technical Field

The embodiments disclosed herein relate to an electroacoustic transducer.

### Background Information

Electrostatic electroacoustic transducers are a kind of electroacoustic transducer that converts an electrical signal into an acoustic sound. An electroacoustic transducer includes two planar fixed electrodes and a planar vibration body. The fixed electrodes face each other across a space, and the vibration body is provided between the fixed electrodes. A DC (direct-current) bias voltage is applied to the vibration body, and an AC (alternating-current) drive signal is applied to the two fixed electrodes. By applying a drive signal to these fixed electrodes, an electric field is generated across the fixed electrodes, causing the vibration body to be driven and emit sound. It is difficult for this kind of electroacoustic transducer to emit a large volume of sound, compared to an electromagnetic electroacoustic transducer, which uses a voice coil. Still, an advantage is that an electroacoustic transducer is capable of generating an acoustic waveform more true to the waveform of the drive signal. In view of this advantage, electroacoustic transducers are used as headphones and similar high-grade products. Another advantage of electroacoustic transducers is that a reproduction sound emitted from them has a smaller amount of attenuation over a distance. In view of this advantage, electroacoustic transducers are used to reproduce a guide sound at sites such as tourist spots.

These conventional electroacoustic transducers uniformly drive the entirety of the vibration body in the all/entire frequency range. This configuration can make it difficult to adjust frequency response characteristics of electroacoustic transducers. Also, electroacoustic transducers are vulnerable to moisture and/or dust, and this makes a moisture and/or dust preventive cover indispensable for protecting a unit including the fixed electrodes and the vibration body. Using a moisture preventive cover and/or a dust preventive cover, however, causes a decrease in the volume of high-frequency sound. It is impossible or difficult to compensate for the decreased volume of high-frequency sound because it is structurally difficult for electroacoustic transducers to adjust frequency response characteristics. Further, electroacoustic transducers have such a structure that supports the vibration body only at its circumference. This structure makes the vibration body likely to contact the fixed electrodes at a center portion of the vibration body, which is a portion of maximum amplitude. This has made the vibration body limited to a level of amplitude at which no contact with the fixed electrodes occurs.

JP2016-82378A discloses an electroacoustic transducer in which a plurality of protrusions are arranged uniformly over opposing surfaces of two fixed electrodes and in which a vibration body is supported by the two fixed electrodes such that the vibration body is sandwiched between the plurality of protrusions of one fixed electrode and the plurality of protrusions of the other fixed electrode. This configuration, in which the vibration body is supported by the uniformly arranged protrusions, eliminates or minimizes contact of the center portion of the vibration body with the fixed electrodes. The electroacoustic transducer disclosed in JP2016-82378A, however, is similar to the above-described conventional electroacoustic transducers in that the electroacoustic transducer uniformly drives the entirety of the vibration body in the all/entire frequency range, making it difficult to adjust frequency response characteristics of the electroacoustic transducer.

The present disclosure has been made in view of the above-described circumstances, and it is an object of the present disclosure to provide an electroacoustic transducer whose frequency response characteristics are more easily adjustable.

### SUMMARY

According to one aspect of the present disclosure, an electroacoustic transducer includes a first fixed electrode, a second fixed electrode, and a vibration body. The first fixed electrode and the second fixed electrode face each other across a space. The first fixed electrode includes a plurality of first protrusions that are provided on a first electrode surface of the first fixed electrode and that protrude toward the second fixed electrode. The plurality of first protrusions are arranged at a first arrangement density that varies depending on a position of the plurality of first protrusions on the first electrode surface. The second fixed electrode includes a plurality of second protrusions that are provided on a second electrode surface of the second fixed electrode and that protrude toward the first fixed electrode. The plurality of second protrusions are arranged at a second arrangement density that varies depending on a position of the plurality of second protrusions on the second electrode surface. The vibration body is sandwiched between leading end portions of the plurality of first protrusions and leading end portions of the plurality of second protrusions.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a cross-sectional view of an electroacoustic transducer according to one embodiment of the present disclosure cut along the Ib-Ib′ line illustrated in FIG. 2, illustrating a configuration of this electroacoustic transducer;

FIG. 2 is a cross-sectional view of the electroacoustic transducer according to the one embodiment cut along the Ia-Ia′ line illustrated in FIG. 1;

FIG. 3 is a cross-sectional view of an electroacoustic transducer according to another embodiment of the present disclosure cut along the Ib-Ib′ line illustrated in FIG. 4, illustrating a configuration of this electroacoustic transducer;

FIG. 4 is a cross-sectional view of the electroacoustic transducer according to the another embodiment cut along the Ia-Ia′ line illustrated in FIG. 3; and

FIG. 5 is an illustration of a configuration of an electroacoustic transducer according to still another embodiment of the present disclosure.

### DESCRIPTION OF THE EMBODIMENTS

Embodiments of the present disclosure will be described by referring to the accompanying drawings.

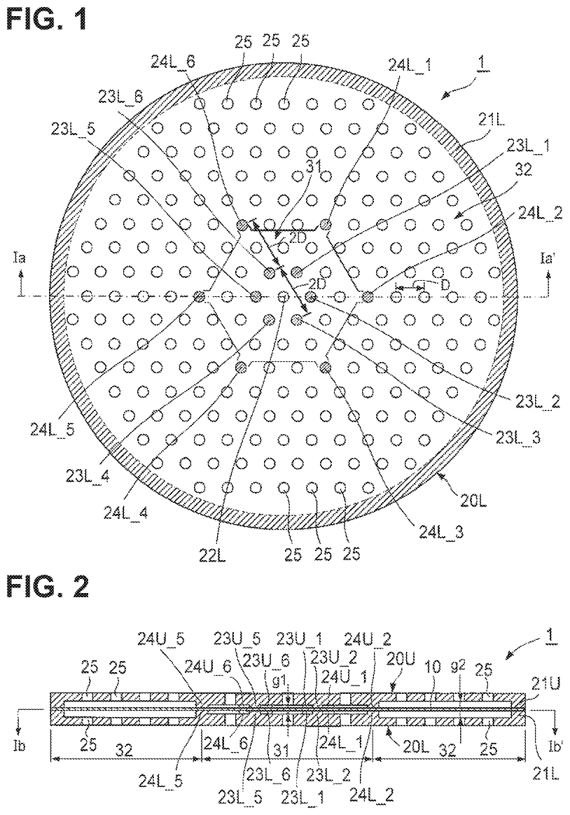

FIG. 1 is an illustration of a configuration of an electroacoustic transducer 1 according to one embodiment of the present disclosure. FIG. 2 is a cross-sectional view of the electroacoustic transducer 1 cut along the Ia-Ia′ line illustrated in FIG. 1. FIG. 1 is a cross-sectional view of the electroacoustic transducer 1 cut along the Ib-Ib′ line illustrated in FIG. 2. The electroacoustic transducer 1 is a speaker unit in a headphone.

As illustrated in FIGS. 1 and 2, the electroacoustic transducer 1 includes a vibration body 10, a fixed electrode 20U, and a fixed electrode 20L. In this one embodiment, the fixed electrode 20U and the fixed electrode 20L are identical to each other in configuration. In view of this, where it is not particularly necessary to distinguish the fixed electrode 20U and the fixed electrode 20L from each other, the indicators “L” and “U” at the ends of the fixed electrodes will be omitted.

The vibration body 10 (a non-limiting example of which is a vibration plate) is made up of a substrate and a conduction film (conduction layer) formed on one surface of the substrate. The substrate is an insulating and flexible synthetic resin film (insulation layer), examples including, but not limited to, a PET (polyethyleneterephthalate) film and a PP (polypropylene) film. The conduction film is formed by depositing a conductive metal onto the one surface of the substrate.

The fixed electrode 20 is made up of a synthetic resin sheet and a conduction film (conduction layer) formed on one surface of the synthetic resin sheet. The synthetic resin sheet is an insulating and plastic synthetic resin sheet (insulation layer), examples including, but not limited to, a PET sheet and a PP sheet. The conduction film is formed by depositing a conductive metal onto the one surface of the synthetic resin sheet. The surface of the fixed pole 20 on which the conduction film is formed is a non-limiting example of the “electrode surface” recited in the appended claims. The fixed electrode 20 also has a plurality of holes 25. The plurality of holes 25 penetrate the fixed electrode 20, connecting its front surface and back surface to each other, so that air and a sound wave are allowed to pass through the plurality of holes 25. In this one embodiment, the holes 25 are arranged such that an entire one surface of the fixed electrode 20 is divided into a plurality of imaginary equilateral triangles and that each hole 25 is arranged at a position corresponding to the apex of each equilateral triangle.

The fixed electrodes 20U and 20L face each other across a space. The conduction layer of the fixed electrode 20U is provided on the surface of the fixed electrode 20U facing the fixed electrode 20L, and the conduction layer of the fixed electrode 20L is provided on the surface of the fixed electrode 20L facing the fixed electrode 20U. The vibration body 10 and the fixed electrode 20 have similar circular shapes as viewed downward from a viewpoint over the electroacoustic transducer 1 in FIG. 2. The electroacoustic transducer 1 is formed by superimposing planar surfaces of the vibration body 10 and the fixed electrode 20 on each other.

The vibration body 10 is supported by the fixed electrode 20U and the fixed electrode 20L such that the vibration body 10 is provided between the fixed electrode 20U and the fixed electrode 20L. The fixed electrode 20U includes a plurality of first protrusions protruding toward the fixed electrode 20L. The fixed electrode 20L includes a plurality of second protrusions protruding toward the fixed electrode 20U. The vibration body 10 is sandwiched between leading end portions of the plurality of first protrusions and leading end portions of the plurality of second protrusions. Specifically, a binding agent is applied to the leading end portions of the first and second protrusions, and the vibration body 10 is fixed to the leading end portions of the first and second protrusions via the binding agent. Thus, the vibration body 10 is fixed to the leading end portions of the first and second protrusions.

As illustrated in FIG. 1, the plurality of second protrusions include an annular protrusion 21L, cylindrical protrusions 23L_1 to 23L_6, and cylindrical protrusions 24L_1 to 24L_6. The annular protrusion 21L constitutes a circumference portion (edge portion) of the fixed electrode 20L. The cylindrical protrusions 23L_1 to 23L_6 are arranged at positions corresponding to the apexes of a regular hexagon surrounding the center portion 22L of the fixed electrode 20L. The cylindrical protrusions 24L_1 to 24L_6 are arranged at positions corresponding to the apexes of another regular hexagon located outside the above regular hexagon and surrounding the above regular hexagon.

The plurality of first protrusions include an annular protrusion 21U, cylindrical protrusions 23U_1 to 23U_6, and cylindrical protrusions 24U_1 to 24U_6. The annular protrusion 21U faces the annular protrusion 21L. The cylindrical protrusions 23U_1 to 23U_6 respectively face the cylindrical protrusions 23L_1 to 23L_6. The cylindrical protrusions 24U_1 to 24U_6 respectively face the cylindrical protrusions 24L_1 to 24L_6. It is to be noted that in FIG. 2, the cylindrical protrusion 23U_3, 23U_4, 24U_3, and 24U_4 are omitted for illustration purposes.

On the surface of the fixed electrode 20U facing the fixed electrode 20L, no conduction film is formed in the region where the annular protrusion 21U is provided. On the surface of the fixed electrode 20L facing the fixed electrode 20U, no conduction film is formed in the region where the annular protrusion 21L is provided. At the circumference portions of the fixed electrodes 20U and 20L, a circumference portion of the vibration body 10 is sandwiched between: a leading end portion of the annular protrusion 21L, which is an insulation member; and a leading end portion of the annular protrusion 21U, which is an insulation member.

A conduction film is formed on the surface of the fixed electrode 20U facing the fixed electrode 20L. On the conduction film, holes are formed for the cylindrical protrusions 23U_1 to 23U_6 and 24U_1 to 24U_6 to pass through. Similarly, a conduction film is formed on the surface of the fixed electrode 20L facing the fixed electrode 20U. On the conduction film, holes are formed for similar purposes.

The cylindrical protrusions 23U_1 to 23U_6 and 24U_1 to 24U_6 of the fixed electrode 20U pass through the holes of the conduction film of the fixed electrode 20U and protrude toward the vibration body 10. Similarly, the cylindrical protrusions 23L_1 to 23L_6 and 24L_1 to 24L_6 of the fixed electrode 20L (which respectively face the cylindrical protrusions 23U_1 to 23U_6 and 24U_1 to 24U_6 of the fixed electrode 20U) pass through the holes of the conduction film of the fixed electrode 20L and protrude toward the vibration body 10.

Now that the leading end portions of the cylindrical protrusions (insulation members) of the fixed electrode 20U are past the holes of the conduction film of the fixed electrode 20U and that the leading end portions of the cylindrical protrusions (insulation members) of the fixed electrode 20L are past the holes of the conduction film of the fixed electrode 20L, the vibration body 10 is sandwiched between these leading end portions. This configuration ensures that the conduction film of the vibration body 10 and the conduction film of the fixed electrode 20U are electrically insulated from each other and that the conduction film of the vibration body 10 and the conduction film of the fixed electrode 20L are electrically insulated from each other.

In this one embodiment, the space between the fixed electrodes 20U and 20L is divided into two regions different from each other in frequency response characteristics. One region is a first region 31. The first region 31 is defined within the cylindrical protrusions 24U_1 to 24U_6 of the fixed electrode 20U and the cylindrical protrusions 24L_1 to 24L_6 of the fixed electrode 20L, which respectively face the cylindrical protrusions 24U_1 to 24U_6. The other region is a second region 32. The second region 32 is defined between the cylindrical protrusions 24U_1 to 24U_6 and 24L_1 to 24L_6 and the annular protrusions 21U and 21L. The first region 31 faces a user's earhole when the headphone is placed on the user's ear. The second region 32 is located outside the first region 31 and surrounds the first region.

As illustrated in FIG. 1, the circular fixed electrode 20L has an electrode surface (which is a non-limiting example of the “first electrode surface” or the “second electrode surface”), and the boundary between the first region 31 and the second region 32 is shown on the electrode surface. The boundary forms a hexagon defined by radially outermost arc sections of the cylindrical protrusions 24L_1 to 24L_6 and lines that extend radially internally from the radially outermost arc sections and then bend and pass radially internally under the holes 25. Thus, this hexagon has outward-protruding apexes. It is to be noted, however, that this hexagon is a non-limiting example of the boundary between the first region 31 and the second region 32 and that the boundary may be a hexagon with non-protruding apexes or may be a circular shape.

Stiffness is a property of the vibration body 10 that affects frequency response characteristics of the electroacoustic transducer 1. The stiffness of the vibration body 10 is affected by the support structure of the vibration body 10. In this one embodiment, the arrangement of the first and second protrusions supporting the vibration body 10 in the first region 31 is different from the arrangement of the first and second protrusions supporting the vibration body 10 in the second region 32. In this one embodiment, the stiffness of the vibration body 10 in the first region 31 is affected by the arrangement density (the number of protrusions per unit area) of the protrusions in the first region 31, and the stiffness of the vibration body 10 in the second region 32 is affected by the arrangement density of the protrusions in the second region 32. The arrangement density is a non-limiting example of the “first arrangement density” and the “arrangement density” recited in the appended claims.

In the example illustrated in FIG. 1, the intercentral distance between two adjacent holes 25 formed in the fixed electrode 20 is assumed as D. In the first region 31, the distance between two inner protrusions aligned along a diameter direction of the fixed electrode is 2D (for example, the intercentral distance between the cylindrical protrusions 23L_6 and 23L_3 is 2D). Also, the distance between one of two inner protrusions aligned along the diameter direction of the fixed electrode and one of two outer protrusions aligned along the diameter direction of the fixed electrode is 2D (for example, the intercentral distance between the cylindrical protrusions 23L_6 and 24L_6, and the intercentral distance between the cylindrical protrusions 23L_3 and 24L_3 are 2D). In contrast, in the second region 32, the distance between each of the cylindrical protrusions 24U_1 to 24U_6 and 24L_1 to 24L_6 and each of the annular protrusions 21U and 21L is approximately 5D. Thus, the arrangement density of the protrusions is lower in the second region 32 than in the first region 31. This lowness of the arrangement density of the protrusions in the second region 32 greatly affects the stiffness of the vibration body 10 in the second region 32. Specifically, the stiffness of the vibration body 10 in the second region 32 is lower than the stiffness of the vibration body 10 in the first region 31. As a result, the vibration body 10 has a lower low-range reproduction limit in the second region 32 than in the first region 31.

Also in this one embodiment, the gap between the conduction film of the fixed electrode 20U and the conduction film of the fixed electrode 20L in the first region 31 is different from the gap between the conduction film of the fixed electrode 20U and the conduction film of the fixed electrode 20L in the second region 32 (the gap is equivalent to the distance between the fixed electrodes and will be hereinafter referred to as interpolar gap). Specifically, in this one embodiment, the insulation film of the fixed electrode 20 in the first region 31 is larger in thickness than the insulation film of the fixed electrode 20 in the second region 32. Therefore, the interpolar gap is smaller in the first region 31 than in the second region 32.

In the first region 31 and the second region 32, the vibration body 10 receives force F, which is represented by the following equation

F=ε0·S·E·Vin/g² (1)

In this equation, e0 denotes dielectric ratio in the space between the fixed electrodes 20U and 20L, E denotes bias voltage applied to the vibration body 10, S denotes fixed-pole overlap area in the first region 31 or the second region 32, Vin denotes voltage applied across the fixed electrodes, and g denotes interpolar gap in the first region 31 or the second region 32.

In this one embodiment, an interpolar gap gl in the first region 31 is smaller than an interpolar gap g2 in the second region 32. With this configuration, the vibration body 10 receives a greater amount of force F in the first region 31 than in the second region 32. This enables the vibration body 10 to emit sound with a greater amount of sound pressure in the first region 31. In contrast, the interpolar gap is larger in the second region 32 than in the first region 31. This enables the vibration body 10 to vibrate with a greater level of amplitude in the second region 32 than in the first region 31.

Next, an operation of this one embodiment will be described. In this one embodiment, a DC bias voltage is applied to the vibration body 10, and a balanced AC signal is output as an acoustic signal from an amplifier, not illustrated, and applied to the fixed electrodes 20U and 20L. By applying the acoustic signal to the fixed electrode 20U and the fixed electrode 20L, a potential difference occurs between the fixed electrode 20U and the fixed electrode 20L. Upon occurrence of a potential difference, an electrostatic force acts on the vibration body 10, which is provided between the fixed electrode 20U and the fixed electrode 20L, causing the vibration body 10 to be attracted toward either the fixed electrode 20U or the fixed electrode 20L.

Specifically, upon application of an acoustic signal to the fixed electrodes with a positive bias voltage applied to the vibration body 10, a positive voltage may occur at the fixed electrode 20U, and a negative voltage may occur at the fixed electrode 20L. In this case, the electrostatic attraction between the vibration body 10 and the fixed electrode 20U decreases, and the electrostatic attraction between the vibration body 10 and the fixed electrode 20L increases. The portions of the vibration body 10 that are kept out of contact with the protrusions are attracted toward the fixed electrode 20L because of the difference in electrostatic attraction acting on the vibration body 10, and are deformed toward the fixed electrode 20L.

Upon application of an acoustic signal to the fixed electrodes, a negative voltage may occur at the fixed electrode 20U, and a positive voltage may occur at the fixed electrode 20L. In this case, the electrostatic attraction between the vibration body 10 and the fixed electrode 20L decreases, and the electrostatic attraction between the vibration body 10 and the fixed electrode 20U increases. The portions of the vibration body 10 that are kept out of contact with the protrusions are attracted toward the fixed electrode 20U because of the difference in electrostatic attraction acting on the vibration body 10, and are deformed toward the fixed electrode 20U.

Thus, the vibration body 10 is deformed (bent) upward or downward as viewed in FIG. 2, which depends on the acoustic signal. By successively changing the deformation direction, the vibration body 10 vibrates and generates a form of sound wave corresponding to how the vibration body 10 is vibrating (such as vibration frequency, amplitude, and phase). The sound wave generated passes through the fixed electrodes 20, which have acoustic transparency, and is emitted as a sound to the outside of the electroacoustic transducer 1.

Incidentally, in this one embodiment, the first region 31 and the second region 32 are different from each other in the arrangement density of the protrusions and the interpolar gap. With this configuration, the vibration body 10 has different vibration characteristics in the first region 31 and the second region 32. This will be described in detail below.

In this one embodiment, the arrangement density of the protrusions in the second region 32 is lower than the arrangement density of the protrusions in the first region 31. This makes the stiffness of the vibration body 10 in the second region 32 lower than the stiffness of the vibration body 10 in the first region 31. This, in turn, makes the low-range reproduction limit in the second region 32 lower than the low-range reproduction limit in the first region 31. As a result, the vibration body 10 in the second region 32 is capable of vibrating in a low frequency range which is lower in frequency than the low-range reproduction limit in the first region 31 and in which the vibration body 10 is unable to vibrate in the first region 31.

Also in this one embodiment, the interpolar gap in the first region 31 is smaller than the interpolar gap in the second region 32. With this configuration, the vibration body 10 is driven with a greater amount of force in the first region 31 than in the second region 32. This makes it easier to increase sound pressure in the first region 31 than in the second region 32.

Also in this one embodiment, the interpolar gap in the second region 32, which is lower in low-range reproduction limit, is greater than the interpolar gap in the first region 31. This enables the vibration body 10 to vibrate with a greater level of amplitude in the second region 32 than in the first region 31. Thus, in this one embodiment, the vibration body 10 is capable of vibrating with a greater level of amplitude and increasing the volume of sound in the second region 32, which is lower in low-range reproduction limit.

As has been described hereinbefore, in this one embodiment, the vibration body 10 has different frequency response characteristics in the first region 31 and the second region 32. Because of this difference, the frequency response characteristics of the electroacoustic transducer 1 can be adjusted by adjusting the area ratio between the first region 31 and the second region 32 and/or the interpolar gap ratio between the first region 31 and the second region 32. Specifically, sound pressure can be adjusted to a high-frequency sound pressure suitable for a reproduction in the first region 31 and to a low-range sound pressure suitable for a reproduction in the second region 32.

Also in this one embodiment, the vibration body 10 has a higher level of stiffness in the first region 31 and receives a greater amount of force in the first region 31. In view of this, the first region 31 is suitable for a mid-frequency to high-frequency reproduction. The second region 32 is located outside the first region 31, and the vibration body 10 has a lower level of stiffness in the second region 32. In view of this, the second region 32 is suitable for a low-range reproduction. Then, in this one embodiment, when the headphone is placed on the user's ear, the first region 31 faces the user's earhole (the first region 31 is suitable for a mid-frequency to high-frequency reproduction). This configuration ensures that a mid-frequency or high-frequency sound emitted from the first region 31 is directly transmitted to the earhole and is appropriately internalized (localized inside the user's head). The above configuration also ensures that in the second region 32, which is located outside the first region 31, a low-range sound is emitted with a sufficient level of sound volume, ensuring that a suitable sound-field reproduction is realized.

While one embodiment of the present disclosure has been described hereinbefore, the present disclosure may be embodied in many different forms, some non-limiting examples of which will be described below.

(1) In the above-described embodiment, the space between the two fixed electrodes is divided into two regions. Another possible example is that the space is divided into three or more regions.

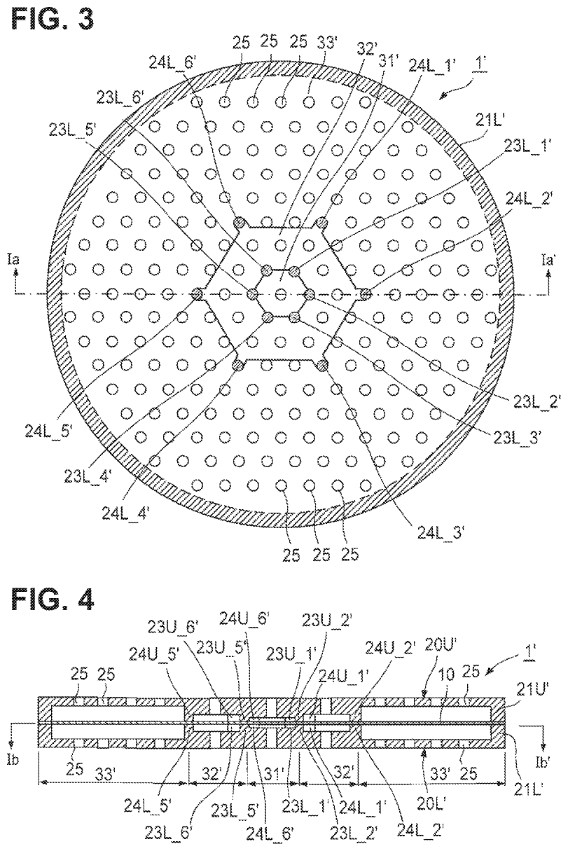

FIGS. 3 and 4 illustrate a configuration of an electroacoustic transducer 1′. In the electroacoustic transducer 1′, the space between the fixed electrodes 20U′ and 20L′ is divided into three concentric regions 31′, 32′, and 33′. FIG. 4 is a cross-sectional view of the electroacoustic transducer 1′ cut along the Ia-Ia′ line illustrated in FIG. 3, and FIG. 3 is a cross-sectional view of the electroacoustic transducer 1′ cut along the Ib-Ib′ line illustrated in FIG. 4.

Similarly to the above-described embodiment, an annular protrusion 21U′ is provided at a circumference portion (edge portion) of the opposing surface of the fixed electrode 20U′ facing the fixed electrode 20L′. An annular protrusion 21L′ is provided at a circumference portion (edge portion) of the opposing surface of the fixed electrode 20L′ facing the fixed electrode 20U′. The annular protrusions 21U′ and 21L′ protrude toward each other. A circumference portion of a vibration body 10 is supported by and sandwiched between leading end portions of the annular protrusions 21U′ and 21L′.

Cylindrical protrusions 23U_1′ to 23U_6′ and 23L_1′ to 23L_6′ are provided at center portions of the fixed electrodes 20U′ and 20L′. The cylindrical protrusions 23U_1′ to 23U_6′ and 23L_1′ to 23L_6′ are arranged at positions corresponding to the apexes of a regular hexagon. The vibration body 10 is supported by and sandwiched between the leading end portions of the cylindrical protrusions 23U_1′ to 23U_6′ and the leading end portions of the cylindrical protrusions 23L_1′ to 23L_6′.

On the opposing surfaces of the fixed electrodes 20U′ and 20L′, cylindrical protrusions 24U_1′ to 24U_6′ are provided outside the cylindrical protrusions 23U_1′ to 23U_6′; and cylindrical protrusions 24L_1′ to 24L_6′ are provided outside the cylindrical protrusions 23L_1′ to 23L_6′. The vibration body 10 is supported by and sandwiched between leading end portions of the cylindrical protrusions 24U_1′ to 24U_6′ and leading end portions of the cylindrical protrusions 24L_1′ to 24L_6′.

The first region 31′ is a region defined within the cylindrical protrusions 23U_1′ to 23U_6′ and 23L_1′ to 23L_6′. The second region 32′ is a region defined between: the cylindrical protrusions 23U_1′ to 23U_6′ and 23L_1′ to 23L_6′; and the cylindrical protrusions 24U_1′ to 24U_6′ and 24L_1′ to 24L_6′. A third region 33′ is defined between: the cylindrical protrusions 24U_1′ to 24U_6′ and 24L_1′ to 24L_6′; and the annular protrusions 21U′ and 21L′.

In the electroacoustic transducer 1′, the arrangement density of the protrusions is highest in the first region 31′. The arrangement density of the protrusions in the second region 32′ is lower than the arrangement density of the protrusions in the first region 31′. The arrangement density of the protrusions in the third region 33′ is lower than the arrangement density of the protrusions in the second region 32′. With this configuration, the low-range reproduction limit is lowest in the third region 33′, higher in the second region 32′, and highest in the first region 31′.

Also in the electroacoustic transducer 1′, the interpolar gap is smallest in the first region 31′. The interpolar gap in the second region 32′ is greater than the interpolar gap in the first region 31′. The interpolar gap in the third region 33′ is greater than the interpolar gap in the second region 32′. With this configuration, the amount of force that the vibration body 10 receives is greatest in the first region 31′, smaller in the second region 32′, and smallest in the third region 33′.

In the electroacoustic transducer 1′, the space between the fixed electrodes 20U′ and 20L′ is divided into three regions 31′, 32′, and 33′, which are different from each other in the distance between the protrusions and in the interpolar gap. This configuration ensures that frequency response characteristics can be more finely adjusted than in the above-described embodiment.

(2) Between the two fixed electrodes, cylindrical protrusions to support the vibration body may be provided throughout the electrode surface of each fixed electrode. Also, with the interpolar gap kept uniform, the distance between the protrusions may vary gradually based on a position on the electrode surface. A possible example is that the distance between the protrusions gradually decreases along a direction from the circumference portions toward the center portions of the two fixed electrodes.

(3) Between the two fixed electrodes, both the interpolar gap and the distance between the protrusions may be gradually changed based on a position on the electrode surface of each fixed electrode. A possible example is that the interpolar gap gradually decreases and the distance between the protrusions gradually varies along the direction from the circumference portions toward the center portions of the two fixed electrodes.

(4) In the above-described embodiment, the first region 31, which is suitable for a mid-frequency to high-frequency reproduction, is positioned at the center portion of the electrode surface of each fixed electrode. Another possible example is that the position of the first region 31 is shifted from the center portion, thereby adjusting the localization position inside the user's head.

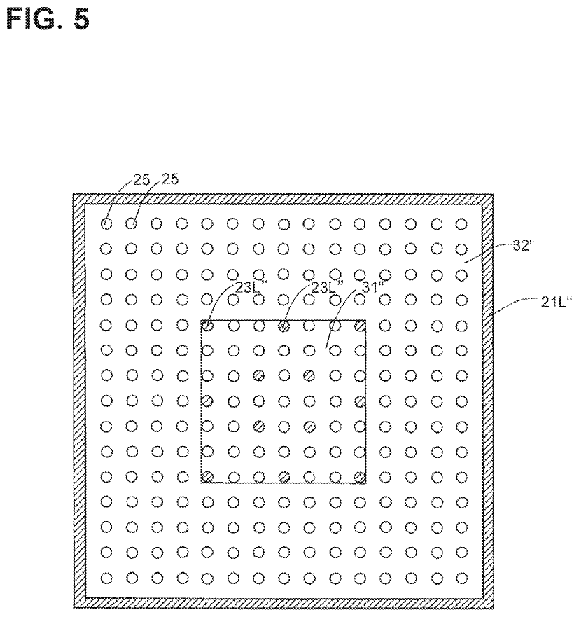

(5) In the above-described embodiment, the fixed electrodes and the vibration body have circular shapes in plan view. This configuration, however, is not intended as limiting the fixed electrodes and the vibration body to circular shapes. The fixed electrodes and the vibration body may have other than circular shapes in plan view. For example, the fixed electrodes and the vibration body may have rectangular shapes in plan view, as illustrated in FIG. 5. In the example illustrated in FIG. 5, a protrusion 21L″ has four sides surrounding a rectangular fixed electrode. The fixed electrode has a rectangular first region 31″ and a second region 32″. The second region 32″ surrounds the first region 31″. As illustrated in FIG. 5, a plurality of holes 25 are provided throughout the surface of the fixed electrode, and a plurality of cylindrical protrusions 23L″ are provided in the first region 31″, similarly to the above-described embodiment. Also as illustrated in FIG. 5, the arrangement density of the protrusions in the second region 32″ is lower than the arrangement density of the protrusions in the first region 31″. The distance between the fixed electrodes in the first region 31″ is shorter than the distance between the fixed electrodes in the second region 32″ (this configuration is not illustrated in FIG. 5). The embodiment illustrated in FIG. 5 provides effects similar to the effects provided in the above-described embodiment.

(6) The above-described cylindrical protrusion and annular protrusion may be integrally formed with the fixed electrode, as in the above-described embodiment, or may be formed separately from the fixed electrode and bonded to the fixed electrode. Another possible example is that either the cylindrical protrusion or the annular protrusion is formed separately from the fixed electrode and bonded to the fixed electrode.

The electroacoustic transducer according to the above-described embodiment is useful in that frequency response characteristics are more easily adjustable.

As used herein, the term “comprise” and its variations are intended to mean open-ended terms, not excluding any other elements and/or components that are not recited herein. The same applies to the terms “include”, “have”, and their variations.

As used herein, a component suffixed with a term such as “member”, “portion”, “part”, “element”, “body”, and “structure” is intended to mean that there is a single such component or a plurality of such components.

As used herein, ordinal terms such as “first” and “second” are merely used for distinguishing purposes and there is no other intention (such as to connote a particular order) in using ordinal terms. For example, the mere use of “first element” does not connote the existence of “second element”; otherwise, the mere use of “second element” does not connote the existence of “first element”.

As used herein, approximating language such as “approximately”, “about”, and “substantially” may be applied to modify any quantitative representation that could permissibly vary without a significant change in the final result obtained. All of the quantitative representations recited in the present application shall be construed to be modified by approximating language such as “approximately”, “about”, and “substantially”.

As used herein, the phrase “at least one of A and B” is intended to be interpreted as “only A”, “only B”, or “both A and B”.

Obviously, numerous modifications and variations of the present disclosure are possible in light of the above teachings. It is therefore to be understood that within the scope of the appended claims, the present disclosure may be practiced otherwise than as specifically described herein.

What is claimed is:

1. An electroacoustic transducer comprising:
a first fixed electrode and a second fixed electrode that face each other across a space,
the first fixed electrode comprising a plurality of first protrusions that are provided on a first electrode surface of the first fixed electrode and that protrude toward the second fixed electrode, the plurality of first protrusions being arranged at a first arrangement density that varies depending on a position of the plurality of first protrusions on the first electrode surface,
the second fixed electrode comprising a plurality of second protrusions that are provided on a second electrode surface of the second fixed electrode and that protrude toward the first fixed electrode, the plurality of second protrusions being arranged at a second arrangement density that varies depending on a position of the plurality of second protrusions on the second electrode surface; and
a vibration body sandwiched between leading end portions of the plurality of first protrusions and leading end portions of the plurality of second protrusions.

2. The electroacoustic transducer according to claim 1, wherein each of the first fixed electrode and the second fixed electrode has
a first region located at a center portion of the first electrode surface and a center portion of the second electrode surface, and
a second region which is located outside the first region, which surrounds the first region, and in which the first arrangement density and the second arrangement density are lower than the first arrangement density and the second arrangement density in the first region.

3. The electroacoustic transducer according to claim 1, wherein each of the first fixed electrode and the second fixed electrode has three or more regions different from each other in the first arrangement density and the second arrangement density.
